(19) United States
(12) Patent Application Publication
(10) Pub. No.: US 2009/0271629 A1
(43) Pub. Date: Oct. 29, 2009

(54) WIRELESS PAIRING CEREMONY

(75) Inventor: Alain L. Michaud, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/111,218

(22) Filed: Apr. 29, 2008

(51) Int. Cl. H04L 9/32

(52) U.S. Cl. 713/172

(57) ABSTRACT

A security token is coupled to a computer and is available for use by both local and remote processes for on-demand response to a challenge. To minimize the security risk of an unattended session, the challenge may be issued to verify the presence of the token. When the token has a user interface, it may be used in conjunction with the computer to require that a user also participate in transferring displayed data between the token and computer. This helps to ensure that not only the token, but the user are both present at the computer during operation. For the most sensitive operations, such a confirmation may be required with each data submission.

### BACKGROUND

The security threat posed when using a computer is an issue for virtually every computer user. Issues such as identity theft, phishing, fraud, viruses, and spam are a concern to even those who don't necessarily use the Internet for shopping or other direct financial transactions.

Fraud and identify theft impact not only consumers, but also the businesses and financial institutions that are victimized as well.

A token, such as a smart card, can be used for authentication to a computer or website. A one-time authentication remains in effect until an explicit log out occurs or until a timeout mechanism is activated. Such, timeout mechanisms terminate a session after a period of inactivity. However, especially on public-use computers, the inactive period before a session times out is particularly vulnerable because the live session can simply be continued by another party. Even when a session is logged out, but an associated window is left open, session variables may remain that present a risk of compromise.

### SUMMARY

A proximity based authentication scheme allows not only local but also remote processes to continuously check for the presence of a token. Rather than relying on a user to log out, or for a timeout mechanism to activate, processes supporting sessions can actively check for the presence of the token, or even present a challenge to assure presence of both the token and an associated user.

An operating system, a local application, a remote server, or a remote application may all seek authentication of the token/user and periodically check that the token/user is present. When remote services are using the token, the local machine may simply route the authentication or presence verification request directly to the token.

For remote authentication, a server process may directly query the token. Alternatively, a client of the server process may perform the periodic verification on behalf of the server process.

When a combination of elements is used for two-factor authentication, as in, “something you have plus something you know”, a message may be displayed on the local screen to request an action by the user. If the token has an I/O capability, the request may be routed directly to the token for processing. In this case, the token may cryptographically authenticate the user's data input (e.g. digitally sign) so that a rogue process doesn't spoof the result.

In another embodiment, a special token has a first interface for normal connection to a computer and a second interface that supports a connection with a wireless fob. The wireless fob contains a cryptographic unit that is capable of periodic communication with the token. The token will perform authentication functions only while the fob is within wireless communication range. If the fob cannot be contacted by the token, the token can shut down any user-related sessions or authorizations supported by the token.

### BRIEF DESCRIPTION OF THE DRAWINGS

FIG. 1 is a block diagram of a computer suitable to support a wireless pairing ceremony;

FIG. 2 is a block diagram illustrating pairing relationships; and

FIG. 3 is a method of selecting pairing ceremony parameters.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______ ’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

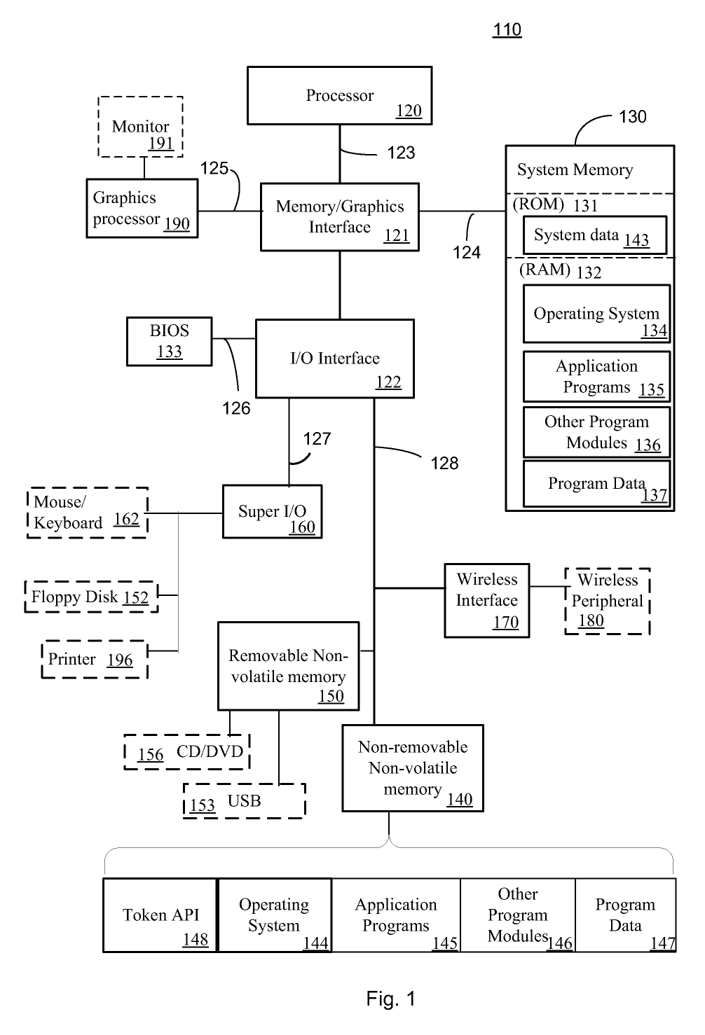

With reference to FIG. 1, an exemplary system for implementing the claimed method and apparatus includes a general purpose computing device in the form of a computer 110. Components shown in dashed outline are not technically part of the computer 110, but are used to illustrate the exemplary embodiment of FIG. 1. Components of computer 110 may include, but are not limited to, a processor 120, a system memory 130, a memory/graphics interface 121, also known as a Northbridge chip, and an I/O interface 122, also known as a Southbridge chip. The system memory 130 and a graphics processor 190 may be coupled to the memory/graphics interface 121. A monitor 191 or other graphic output device may be coupled to the graphics processor 190.

A series of system busses may couple various system components including a high speed system bus 123 between the processor 120, the memory/graphics interface 121 and the I/O interface 122, a front-side bus 124 between the memory/graphics interface 121 and the system memory 130, and an advanced graphics processing (AGP) bus 125 between the memory/graphics interface 121 and the graphics processor 190. The system bus 123 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. The system ROM 131 may contain permanent system data 143, such as identifying and manufacturing information. In some embodiments, a basic input/output system (BIOS) may also be stored in system ROM 131. RAM 132 typically contains data and/or program modules that are immediately accessible to and/or presently being operated on by processor 120. By way of example, and not limitation, FIG. 1 illustrates operating system 134, application programs 135, other program modules 136, and program data 137.

The I/O interface 122 may couple the system bus 123 with a number of other busses 126, 127 and 128 that couple a variety of internal and external devices to the computer 110. A serial peripheral interface (SPI) bus 126 may connect to a basic input/output system (BIOS) memory 133 containing the basic routines that help to transfer information between elements within computer 110, such as during start-up.

A super input/output chip 160 may be used to connect to a number of ‘legacy’ peripherals, such as floppy disk 152, keyboard/mouse 162, and printer 196, as examples. The super I/O chip 160 may be connected to the I/O interface 122 with a low pin count (LPC) bus, in some embodiments. The super I/O chip 160 is widely available in the commercial marketplace.

In one embodiment, bus 128 may be a Peripheral Component Interconnect (PCI) bus, or a variation thereof, may be used to connect higher speed peripherals to the I/O interface 122. A PCI bus may also be known as a Mezzanine bus. Variations of the PCI bus include the Peripheral Component Interconnect-Express (PCI-E) and the Peripheral Component Interconnect—Extended (PCI-X) busses, the former having a serial interface and the latter being a backward compatible parallel interface. In other embodiments, bus 128 may be an advanced technology attachment (ATA) bus, in the form of a serial ATA bus (SATA) or parallel ATA (PATA).

The computer 110 may also include other removable/non-removable, volatile/nonvolatile computer storage media. By way of example only, FIG. 1 illustrates a hard disk drive 140 that reads from or writes to non-removable, nonvolatile magnetic media. Removable media, such as a universal serial bus (USB) memory 153 or CD/DVD drive 156 may be connected to the PCI bus 128 directly or through an interface 150. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 1, provide storage of computer readable instructions, data structures, program modules and other data for the computer 110. In FIG. 1, for example, hard disk drive 140 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a mouse/keyboard 162 or other input device combination. Other input devices (not shown) may include a microphone, joystick, game pad, satellite dish, scanner, or the like. These and other input devices are often connected to the processor 120 through one of the I/O interface busses, such as the SPI 126, the LPC 127, or the PCI 128, but other busses may be used. In some embodiments, other devices may be coupled to parallel ports, infrared interfaces, game ports, and the like (not depicted), via the super I/O chip 160.

The computer 110 may operate in a networked environment using logical connections to one or more remote computers, such as a remote computer 180 via a network interface controller (NIC) 170. The remote computer 180 may be a personal computer, a server, a router, a network PC, a peer device or other common network node, and typically includes many or all of the elements described above relative to the computer 110. The logical connection between the NIC 170 and the remote computer 180 depicted in FIG. 1 may include a local area network (LAN), a wide area network (WAN), or both, but may also include other networks. Such networking environments are commonplace in offices, enterprise-wide computer networks, intranets, and the Internet. The remote computer 180 may also represent a web server supporting interactive sessions with computer 110.

In some embodiments, the network interface may use a modem (not depicted) when a broadband connection is not available or is not used. It will be appreciated that the network connection shown is exemplary and other means of establishing a communications link between the computers may be used.

A token 129 may be removably attached to the computer 110. The token 129 may be a smart card or other device capable of cryptographic one-way or mutual authentication between itself and one or more processes on the computer 110 or remote computer 180. A token API 148 may be available for application programs 145 or for a remote computer 180 connected via network 170 to access the token 129. The use of the token 129 and token API 148 are discussed in more detail below.

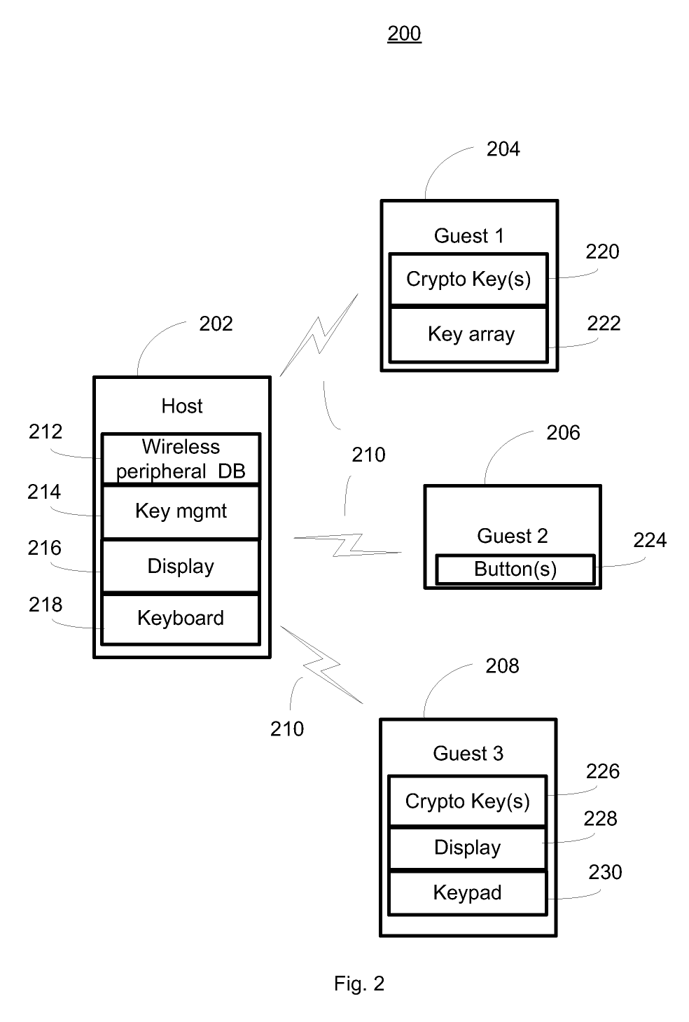

FIG. 2 is block diagram of a representative token 200 that is suitable for use in proximity authentication. The token 200 may be similar to the token 129 of FIG. 1. The token 200 may include a processor 202, a secure memory 204, a cryptographic engine 205, and a communication port 206 that may be used to link the token 200 to a communication port 208 of a computer. The communication port 206 may be wired or wireless.

A user may leave the token 200 at the computer. In one case, the user may leave the token 200 unintentionally. In another case, the user may leave the token 200 intentionally to preserve a session, while the user “just steps away for a moment.” Either case creates a potential security risks including the session being hijacked while the user is away, theft of the token 200, or both. To address this, a wireless connection may be used to allow the token 200 to be kept on a user's person. Then, if the user leaves the computer, the token 200 will not be left behind and according to one of the exemplary methods below, the user's session or sessions will be shut down.

An internal bus 210 may connect the processor 202 to the secure memory 204 and the cryptographic engine 205. The secure memory may include cryptographic keys 212, such as private asymmetric keys or shared symmetric keys. Program code 214 in the secure memory 204 may hold executable instructions for use by the processor for implementing proximity authentication, among other tasks. In some embodiments, cryptographic operations may be performed in software using instructions in the program code 214.

Some versions of the token 200 may also include an input 216 and a display 218. The input 216 may range from a full text entry capability to a simple switch. The display 218 may range from a multi-line full text display to a simple light.

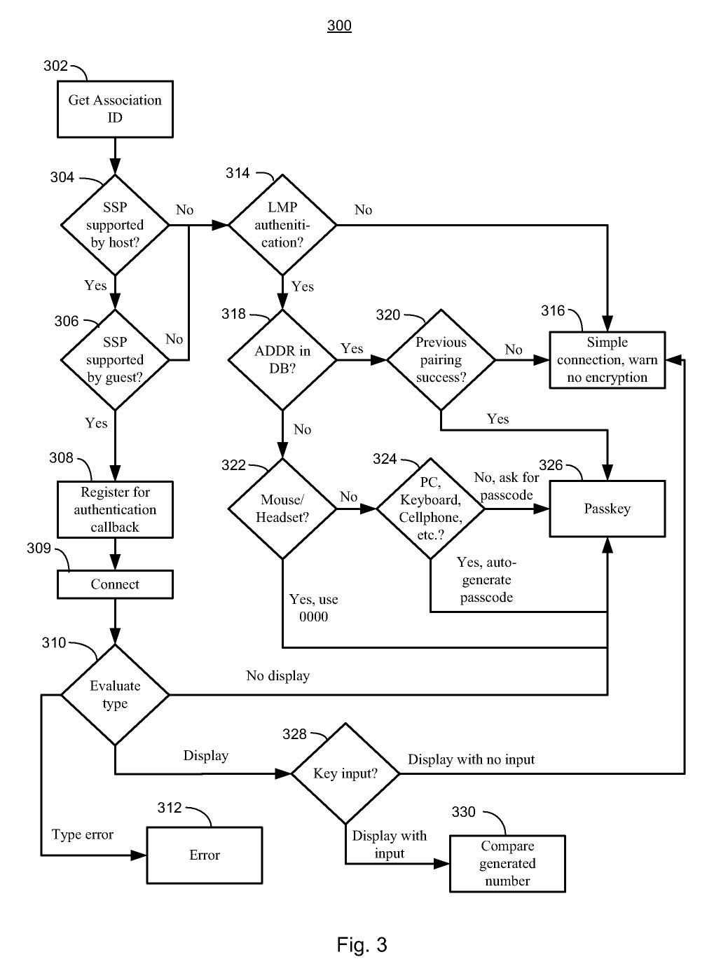

In operation, the token 200 may have several uses, but may include the ability to establish a session with an outside entity via the communication port 208. Data provided in the session may be authenticated as to its source using keys 212 or the data may electronically signed and returned to the sender using the same or different keys. In one embodiment, keys used for signing may be short-term session keys mutually generated by the token and the external party. Such keys may be used only for the lifetime of the session or less. The use of the token 200 in proximity authentication is discussed in more detail with respect to FIGS. 3 and 4 below.

FIG. 2A is a block diagram of a token 250, an alternate embodiment of token 200 of FIG. 2. Like the token 200, the token 250 has a processor 252, a secure memory 254, a cryptographic engine 255, and a first communication port 256 for coupling to a computer port 258. The secure memory 254 may contain both cryptographic keys 262 and program code 264. An internal bus 260 may connect the processor 252 to the secure memory 254 and cryptographic engine 255. Additionally, the internal bus 260 may connect to a second interface 266. The second interface 266, or fob port, may support a wireless connection to a fob 270.

The fob 270 may include a cryptographic engine 272 and a key store 274. The key store 274 may allow one or more keys to be installed corresponding to one or more tokens 250.

In this exemplary embodiment, the token 250 is used for authentication as described above and below. However, the token 250 will only provide authentication services when the fob 270 is within wireless communication range and successfully establishes an authenticated session.

In this manner, the token 250 may be inserted into a port 258, such as a card reader, but will only activate when the fob 270 is in range and successfully performs an authentication process. Because the fob 270 may be small and portable, it can be kept on a users person. Should the user leave the vicinity of the token 250, the token 250 will not be able to maintain the session and will deactivate any computer-side authorizations.

The fob 270 may be personalized to allow use with more than one token 250 by adding keys associated with additional tokens. Thus, the fob 270 may be used with an employer-issued card, used, for example for computer network and database access, as well as with a bank-issued card used for banking, or a government-issued card used, for example, for tax payments.

FIG. 3 is a flow chart of a method 300 of using a token for proximity authentication. For the purpose of illustration, elements of FIG. 1 will be referred to, unless otherwise directed.” At block 302, a token 129 may be presented to a computer, such as computer 110. For example, a user with a token 129 supporting a wireless connection may approach a computer 110. A wireless port on the computer may then activate the token 129 and perform a session-level authentication to create shared session keys with a process on the computer 110, such as an application program interface 148 process.

Given the generally short range of a contactless token, a man-in-the-middle attack is unlikely. If full authentication is used, a man-in-the-middle attack is not an issue. Full authentication allows the computer 110 and the token 129 to authenticate each other using either a shared secret or trusted public keys. The process for mutual authentication is well known and not discussed here in detail.

At block 304, the token 129 may create a session variable with the computer 110, or more specifically, with a process on the computer 110 or even a process on a remote computer 180. To accomplish this, the API 148 may publish calls used by another process to access functions in the token for establishment of a shared secret or session key.

In the meantime, at either block 302 or 304, a user may log in to the computer 110 and subsequently the local or remote process for which the token 129 is establishing a session key. The token 129 may be part of a two-factor authentication for either the computer 110 log in, log in with a local or remote process, or both. In a two-factor authentication, the authenticating party requires “something you have” in this case, the token 129, and “something you know,” typically a password. When this is the case, the token 129 may actually have a relationship with one or more of the authenticating parties and an identity associated with the token 129 may be cryptographically verified using a known key, such as a derived symmetric key, or a verifiable key, such as a PKI key pair from a trusted certificate authority. The use of the token 129 for authentication does not hinder its use in proximity detection.

At block 306, the API 148 may publish its availability, that is, that a token is available. In other embodiments, the API 148 may simply be available and respond to a request for access to the token 129. If token 129 is not available, the API 148 may respond to that effect.

At block 308, the API 148 may accept a request for access to the token in the form of a token authentication request. The API may forward the request to the token 129 and, at block 310, the token 129 may provide an authentication response.

There are a number of ways in which the token 129 can prepare such a response. For example, in one embodiment, the token 129 may simply take challenge data from the request, such as a random number, and encrypt the challenge data with one of its keys 212. If the requesting party has established a session key with the token 129, the session key may be used. If the token 129 is not known to the requesting party or no session key has been established, a PKI private key may be used to encrypt the challenge data and a universal resource locator (URL) to the token's PKI certificate may be included with the response. In another embodiment, the challenge may be sent encrypted and the token 129 must first decrypt the challenge before generating the response. The response may also include a sequence number to prevent replay attacks.

The API 148 may be responsible for returning the response to the requesting party.

At block 312, the requesting party may analyze the response to determine if the response meets its criteria, which may include correctness of the encrypted response, verification of the sequence number, and, in some cases, timeliness of the response.

If, at block 312, the response meets the criteria, the ‘yes’ branch may be taken to block 314, where processing is continued and after some period of time, the requesting party may send another challenge. The period of time may vary based on application. For example, login logic may send an authentication request every second, while a process on the remote computer 180 may send an authentication request every 15 seconds or one minute, depending on the sensitivity of the session. Given the generally higher speeds and better reliability of network connections over past years, a higher repetition rate reduces the likelihood that someone can sit at a recently vacated computer and take over an open session without the previous user taking notice.

In applications where highly sensitive data is handled, the remote session may request that an authentication response accompany each submission made from the computer 110.

If, at block 312, the response fails to meet the criteria, the ‘no’ branch may be followed to block 316. At block 316, the requesting party may immediately end an associated session on the computer 110. If the requesting party is on a remote computer 180, ending the session may include closing a network session with the computer 110. If the requesting party is login logic on the computer 110, the user may be immediately logged out of the operating system and any open connections closed.

The most likely reason for a response to fail to the meet the criteria is simply that the user left the vicinity of the computer 110 and took the token 129 with them. Any session relying on token verification will be closed in no more time than the amount of delay imposed at block 314.

FIG. 4 is a flow chart of another method 400 of using a token for proximity authentication, to allow verification of the presence of a user, the token, or both. The method 400 is similar to the method 300 described above but takes advantage of optional features of the token 200 of FIG. 2, including an input 216 and display 218.

At block 402, an API 148 may support creation of a session with the token 129. At block 404, the session creation may include authentication of the token as discussed above. The authentication process may also include verification of capabilities, including display 218 and input 216.

At block 406, the API 148 may publish its capabilities and make access to the token 129 available to other processes, both local and remote. At block 408, a presence challenge may be presented to the token 129 via the API 148.

At block 410, the API 148 may examine the presence challenge to extract information destined for the token 129 and other information destined for the display/monitor 191. Referring briefly to FIG. 5, the presence challenge 502 is depicted as a record with various fields. The presence challenge 502 may include a header 504 with source/destination information, scheme information 506, a display portion 508, and a token portion 510.

The scheme information 506 may include information used by an API 512 to separate the portions or may include information for use by the token 129 such as encryption method or a key identifier. The display portion 508 may include information that is routed to a display 514, as discussed below. The token portion 510 may include clear or encrypted challenge data that is presented to a token 516.

Returning to FIG. 4 and continuing at block 410, the display portion 508 may be presented on the monitor 191 of the computer 110. A user may then enter the data from the screen into the token 516 using the input 216.

At block 412, the token 129 may then sign/encrypt data entered and add it to any presence challenge data cryptographically altered in the token 129. A presence challenge response may then be returned to the requesting party via the API 148.

Alternatively, information in an encrypted challenge may be decrypted in the token 129 and presented on its internal display 218. The information on the display may be input by the user into the computer keyboard 162. The information input by the user may be combined with any additional data from the token 129 and the resulting presence challenge response returned to the requesting party.

At block 414, the requesting party may analyze the presence challenge response. The use of either display and the input of the opposite unit (e.g. computer monitor 191 and token input 216) requires that the token correctly encrypt the response or decrypt the challenge request and that a user is present to physically transfer the presented data.

At block 414, if the response is valid, processing may continue at block 416. If, at block 414, the response is invalid or not presented within an acceptable time period, the requesting party may end whatever session it is supporting.

The process of FIG. 3 requires the token 129, and if a login is required, the initial presence of a user. The process of FIG. 4 requires that both the token and the user be present each time the presence challenge is made. Because it is presumably to the user's advantage to maintain the session, a user's attempt to thwart the system is both unlikely and will be to the user's detriment.

The API 148 allows both local and remote processes to access the token and to support the challenge response process. The token's ability to store keys or create session keys for more than one simultaneous session allows multiple, independent sessions to verify token presence or presence of both the user and token.

Although the foregoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

We claim:

1. A method of verifying presence of a token at a computer, the method comprising:
creating a communication link between the token and the computer;
activating a process on the computer that creates a session key with the token;
publishing an availability of the process;
accepting a token authentication request from an other process;
providing a token authentication response to the other process;
validating the token authentication response;
continuing a session with the other process following a valid token authentication response; and
ending the session following a failed token authentication response.

2. The method of claim 1, wherein the failed token authentication response is one of a missing token authentication response, an untimely token authentication response, and a failed token authentication response.

3. The method of claim 1, wherein providing the token authentication response comprises cryptographically authenticating a challenge in the token authentication request.

4. The method of claim 1, wherein providing the token authentication response comprises entry of data corresponding to a displayed human presence check and a cryptographic authentication of the data.

5. The method of claim 1, wherein providing the token authentication response comprises entry of data from the token authentication request directly into the token.

6. The method of claim 1, wherein providing the token authentication response comprises activation of an input at the token that causes the token to authenticate a challenge in the token authentication request.

7. The method of claim 1, further comprising:
creating a second communication link using a short range wireless connection between a fob and the token;
authenticating the fob at the token; and
immediately ending the session when the fob cannot be accessed via the second communication link.

8. The method of claim 1, wherein the other process is a login process that logs off a user responsive to a failed token authentication response.

9. The method of claim 1, wherein the other process is a remote process with access to the computer and the session is a remote session on a network.

10. The method of claim 9, wherein the remote process terminates the session following an invalid token authentication response.

11. A system for verifying presence of a token at a computer comprising:
the token including a cryptographic unit, a secure memory, and a communication link for maintaining a communication session with the computer; and
the computer, including:
a port for maintaining the communication session with the computer;
a processor for executing programmable instructions; and
a memory for storing processor-executable programmable instructions comprising:
an interface module that presents an application program interface (API) for communicating with the token; and
a program module that initially authenticates the token and thereafter periodically presents a challenge to the token via the API and interrupts an associated session when the token fails to provide a valid response to the challenge.

12. The system of claim 11, wherein the computer further comprises a network connection and the program module supports communication with a remote process.

13. The system of claim 11, further comprising a fob with a wireless link and a cryptographic engine, wherein the fob establishes a second communication session with the token using a wireless connection on the token that is distinct from the communication link.

14. The system of claim 11, wherein the computer further comprises a display and the program module presents information from the token on the display as part of presenting the challenge.

15. The system of claim 14, wherein the program module accesses a cryptographic function to verify a cryptographically altered form of the challenge plus the information received from the token.

16. The system of claim 14, wherein the token further comprises an input that accepts a form of the information for use in providing a response to the challenge.

17. A computer-readable medium having computer-executable instructions for causing a processor in a computer to implement a method comprising:
establishing a session with a security token;
cryptographically authenticating the security token;
presenting an application program interface (API) that allows communication with the security token using the session;
passing a presence challenge from a process to the security token via the API;
returning a response to the presence challenge to the process via the API;
validating the response to the presence challenge at the process; and
deactivating the process when the validating fails.

18. The computer-readable medium of claim 17, further comprising:
presenting a portion of the presence challenge on a display of the computer; and
inputting the portion of the presence challenge;
wherein returning the response to the presence challenge comprises:
combining the presence challenge from the process with the portion of the presence challenge input to form the response to the presence challenge.

19. The computer-readable medium of claim 17, further comprising:
communicating with a network separate from any communication medium used by the session with the security token;
passing a remote presence challenge received via the network to the security token via the API;
returning a remote response to the remote presence challenge via the API.

20. The computer-readable medium of claim 17, wherein the process is a user login process and wherein deactivating the process comprises logging out a user associated with the security token.
